(19) United States
(12) Patent Application Publication
(10) Pub. No.: US 2018/0068370 A1
(43) Pub. Date: Mar. 8, 2018

(54) PRODUCT PART PICTURE PICKER

(71) Applicant: Wal-Mart Stores, Inc., Bentonville, AR (US)

(72) Inventors: William Ross Allen, Pea Ridge, AR (US); Richard M. Blair, II, Bentonville, AR (US)

(21) Appl. No.: 15/682,947

(22) Filed: Aug. 22, 2017

Related U.S. Application Data
(60) Provisional application No. 62/383,881, filed on Sep. 6, 2016.

(51) Int. Cl. G06Q 30/06

(52) U.S. Cl. CPC G06Q 30/0627; G06Q 30/0283

(57) ABSTRACT

A system is described which aids a customer in finding the correct part for a product. The customer will take a picture of the product (e.g., lawnmower) on a mobile device running an App which is forwarded to a parts identification system. The parts identification system will use analyze the picture and provide several close matches to the user's mobile device. The user will select the closest image which identifies a specific product. The model number, brand, etc. associated with the product, is provided to a parts database which provides a representation of the parts relating to the selected product. The parts identification system may categorize the parts for the customer to narrow down to the desired matching part. The system will then store the selected products and parts for this customer for quicker matches in the future. The system also searched e-Commerce sites for availability.

### RELATED APPLICATIONS

This application claims the benefit of U.S. Provisional Patent No. 62/383,881, filed Sep. 6, 2016, entitled “Product Part Picture Picker,” the contents of which are incorporated by reference herein in their entirety.

### FIELD

The present invention relates to a system that aids customers in finding a correct replacement part; and more specifically to a system that aids customers in finding a correct replacement part for a product from a picture of the product taken by the customer.

### BACKGROUND

When products break or need maintenance, the person fixing or maintaining the product (the “maintenance person”) usually requires replacement parts. Replacement parts typically do not fit or function correctly unless they are specifically designed for the specific product. To get the replacement parts, the maintenance person typically is required to know the manufacturer, model number, and part number. This information is commonly printed on a label on the product. However, after years of use, the information may be removed or become non-readable. Without the manufacturer's name, product number and part number, it can take several tries to locate the proper replacement parts, or the correct part may not be located at all.

It may also be the case that the maintenance person knows the correct information, but when he/she drives to the store to buy the part, it is not carried by that store or is out of stock. This wastes the maintenance person's time and causes frustration.

For example, assume that the maintenance person has a used lawn mower of which the manufacturer and model number are non-readable. Sometimes the number on the spark plug does not convert to a product number used by major spark plug manufacturing companies. In this case, the maintenance person would simply guess by trying to visually match up the current spark plug with the potential replacement spark plug. Since these vary in heat range, point gap and other aspects, it may not perform well. This may require the maintenance person to return to buy another spark plug and try that one. This can become time-consuming and frustrating.

Therefore, currently there is a need for a system that easily and efficiently aids a maintenance person in choosing the correct replacement parts for a product.

### BRIEF SUMMARY

According to aspects of the present inventive concepts there is provided an apparatus and method as set forth in the appended claims. Other features of the inventive concepts will be apparent from the dependent claims, and the description which follows.

At least one embodiment of the current invention provides a system for assisting an maintenance person (referred to as a user) in acquiring a replacement part for a product having a visual identification system adapted to acquire an image of a product and interact with a user to visually identify the product and an open access parts database coupled to the visual identification system, adapted to acquire the product identification information from the visual identification system and provide a representation of at least one part of the identified product to the user, and receive a selection of the user as the replacement part.

The visual identification system may include a user interface adapted for displaying images to the user and receiving selections from the user, an image acquisition device adapted to acquire an image of the product, an image analysis device coupled to the image acquisition device, adapted to analyze the image to identify image features, a product database having prestored images with image features relating to a plurality of products, each image also having associated product information, an image search device coupled to the image analysis device and the product database adapted to search the image features of the product database to find similar product images and provide the similar product images to the user to select. The image search device may be further adapted to receive the product image selected, and identify product identification information from the selected product image.

The image acquisition system and the user interface may be part of a personal computing device that may be a smartphone, tablet, laptop computer, or desktop computer.

The current system may also be described as a system for assisting a user in acquiring a replacement part for a product having a visual identification system adapted to acquire an image of a product, interact with a user to visually identify the product, an open access parts database system coupled to the visual identification system, adapted to receive the product identification and interact with the user to identify the replacement part, and an ecommerce system, coupled to the open access parts database, adapted to indicate the location and availability of the identified part.

The ecommerce system may be remotely coupled to the open access parts database system and have an inventory database of various stores having a plurality of product parts, information on the product parts, and an indication of a number of each part in stock at each location, a controller coupled to the inventory database adapted to receive the part selected by the user and a location where the user would like to purchase the selected part, search the inventory database, and indicate the stores within a predetermined radius of the location where the user would like to purchase the part which have the part in stock.

The current system may be alternatively described as a method of acquiring a replacement part for a product by acquiring an image of the product, searching an open access product database for images that are similar to the acquired image, providing the similar images to the user to select, receiving an indication of the product selected by the user, searching an open access parts database to find parts of the selected product, providing a representation of the parts of the selected product, allowing the user to select a part, and identifying the selected part as the replacement part.

The method may also include the step of searching an ecommerce system to determine locations where the selected part may be purchased.

In another implementation of the method, it may include searching an ecommerce system to determine the price and the estimated time of delivery if purchased on-line.

### BRIEF DESCRIPTION OF SEVERAL VIEWS OF THE DRAWINGS

The above and further advantages may be better understood by referring to the following description in conjunction with the accompanying drawings, in which like numerals indicate like structural elements and features in various figures. The drawings are not necessarily to scale, emphasis instead being placed upon illustrating the principles of the concepts. For example, the dimensions of some of the elements in the figures may be exaggerated relative to other elements to help to improve understanding of various example embodiments. Also, common but well-understood elements that are useful or necessary in a commercially feasible embodiment are often not depicted in order to facilitate a less obstructed view of these various example embodiments.

FIG. 1 is a schematic block diagram of one embodiment of a system in accordance with one aspect of the present invention;

FIG. 2 is a modified flowchart illustrating the functioning of the system of FIG. 1 in which the product is unknown; and

FIG. 3 is a modified flowchart illustrating the functioning of the system of FIG. 1 in the case where the product is known.

### DETAILED DESCRIPTION

At least some of the following exemplary embodiments provide an improved system for automatically finding and purchasing parts for a specific product. Many other advantages and improvements will be discussed in more detail below, or will be appreciated by the skilled person from carrying out exemplary embodiments based on the teachings herein. The exemplary embodiments have been described particularly in relation to a retail store such as a supermarket or general store for grocery and household items. However, it will be appreciated that the example embodiments may be applied in many other specific environments.

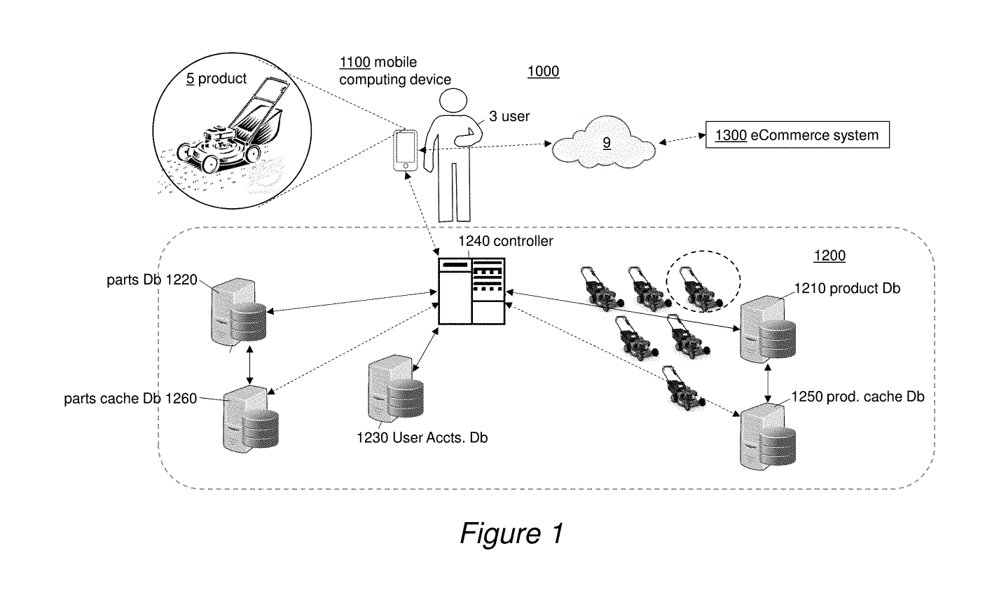

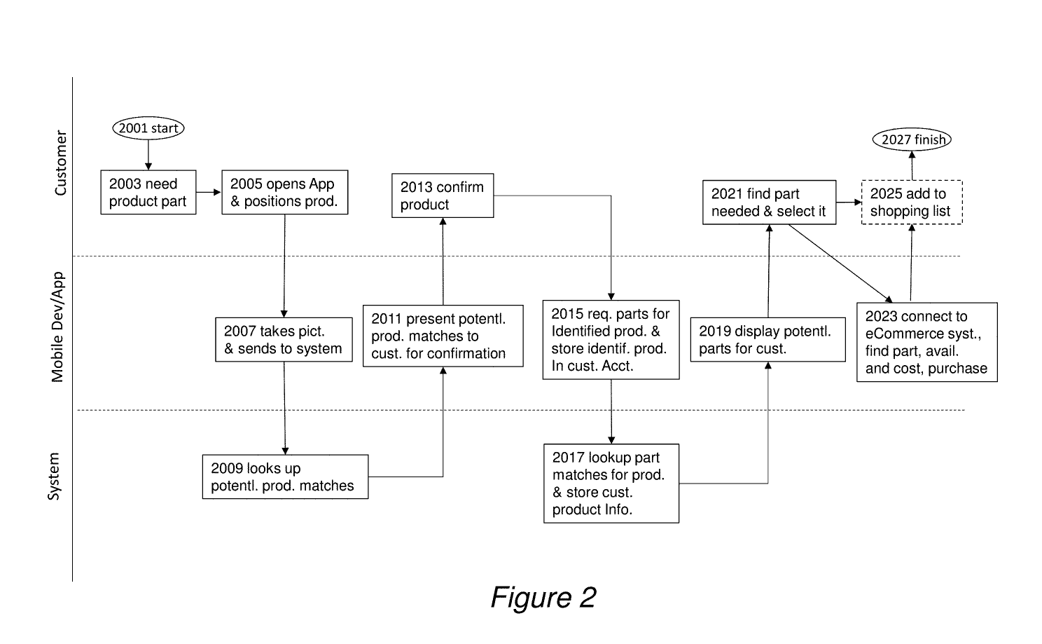

FIG. 1 is a schematic block diagram of one embodiment of a system 1000 for assisting a user in acquiring a replacement part in accordance with one aspect of the present invention. FIG. 2 is a modified flowchart illustrating the functioning of the system 1000 of FIG. 1 in which the product is unknown. The structure and functioning of system 1000 will now be described in connection with both FIGS. 1 and 2.

A maintenance person (referred to as a user 3) wants to maintain his/her product 5, shown here as lawnmower. In step 2001 the process of FIG. 2 starts. In step 2003, user 3 realizes that he/she needs a replacement part for product 5.

In step 2005, user 3 uses a mobile or wireless device referred to as the user's computing device 1100 to open a program of executable instructions referred to as an ‘App’. The user's computing device 1100 may be a computing tablet, a smart phone, a laptop or similar device which includes an image acquisition device 1110 that is typically a camera.

In step 2007, user 3 takes a picture of product 5. The App has executable software which causes the picture to be shown to user 3 and upon the approval of user 3, is then sent to a controller 1240 of a parts identification (ID) system 1200.

In step 2009, controller 1240 analyzes the picture received from computing device 1100 and sends the analysis to a product database 1210. Product database 1210 has a plurality of images and/or analyses of the images and product information corresponding to each of the images. Product database 1210 finds images of products which closely match the image provided to it.

In step 2011, controller 1240 receives the potential matches from product database 1210 and provides them to computing device 1100.

In step 2013, computing device 1100 provides the potential images to user 3. User 3 selects an image displayed which user believes is product 5.

In an optional embodiment, other information associated with the products may be displayed on with the image to make it easier for users 3 to select the correct product. For example, the images may be displayed with other product specifications such as horsepower, cutting width, and year of manufacture.

In step 2015, user's computing device 1100 running the app, provides the selected image and corresponding product information to controller 1240. Controller 1240 then passes this information to a parts database 1220.

In step 2017, parts database 1220 looks up the parts relating to the selected product and provides them to the user's computing device 1100.

In step 2019 user's computing device 1100 displays a representation of the parts of the selected product to the user 3. This may be done in several ways. In one embodiment, they are categorized for the customer to narrow down the selection to fewer relevant parts. This categorization may involve a hierarchical text listing which may expand upon selection of various categories. It may also be implemented as a visual diagram in which the user can select different sections of the product to view and have that part of the product expanded in an exploded view. Various other conventional methods of displaying a number of parts and allowing the user 3 to select the proper part may be employed.

In step 2021, user 3 selects the proper part.

In step 2023, the user may then contact an ecommerce system 1300, such as Walmart.com through user's computing device 1100 and through a network 9, such as the Internet. The user 3 can then check the availability and cost of the part in various stores in a local area, and possibly purchase the replacement part.

Optionally, in step 2025, the user 3 may cause the replacement part to be added to his on-line shopping list for later purchase.

The process finishes at step 2027.

In an alternative embodiment, any of the following information including the image acquired, the potential matching products, product information for the potential matching products, the selected product, the potential matching parts, the selected part is passed from controller 1242 to a user account database 1230, and stored for future use.

This will allow better matching of products and parts for that customer in the future and will make it easier for the customer to find parts for the products in the future.

It sometimes is difficult to choose among several potential product images since many of them may look very similar. It is still difficult even when some of the product information is also provided along with the images. Therefore, in an alternative embodiment, information of the product/image selected by other users is provided to the current user 3 when selecting a product from several potential product images.

In another embodiment, the images of potential products are provided in the order of how closely they match the image acquired by user 3.

The current system allows more accurate identification of replacement parts with little effort on the part of the customer. The system can find the replacement part with a picture and some minimal input from the customer.

Once the product has been entered into the system, the customer will not have to look up the same information again since it's stored and remembered in the system for next time.

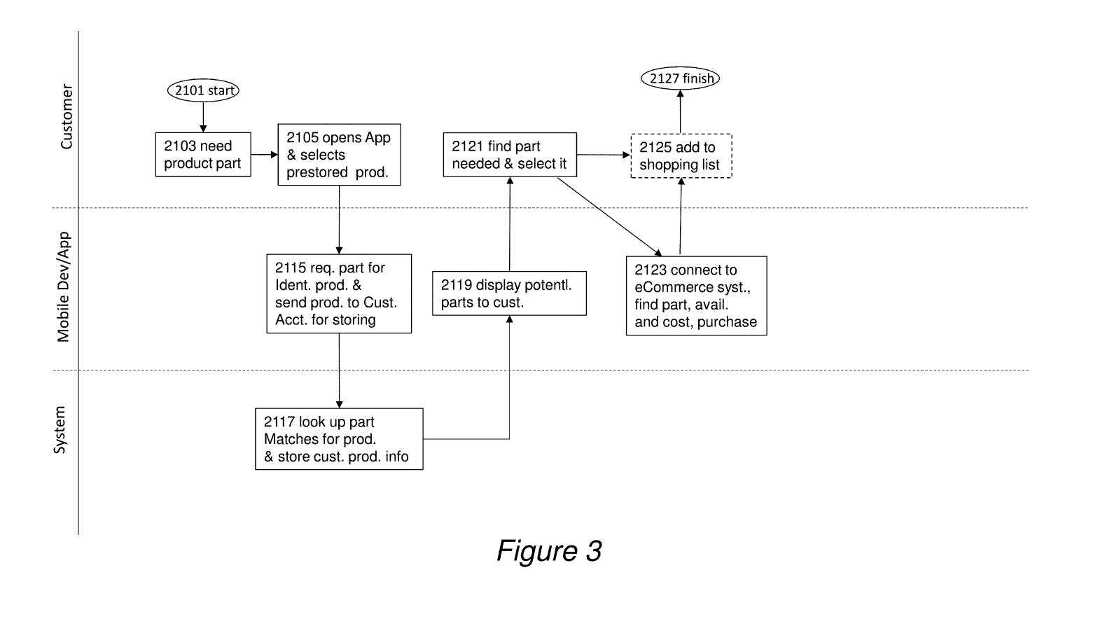

The structure and functioning of system 1000 will now be described in connection with both FIGS. 1 and 3 in which the product has been previously identified.

A maintenance person (user 3) wants to maintain product 5, shown here as lawnmower.

In step 2101 the process of FIG. 2 starts. In step 2103, user 3 realizes that he needs a replacement part for product 5.

In step 2105, user 3 uses user's computing device 1100 to open a program of executable instructions referred to as an ‘App’. The user's computing device 1100 may be a computing tablet, a smart phone, a laptop or similar device.

In step 2115, the user 3 selects the product 5 which has been previously identified and stored as was described in connection with FIG. 2. The user 3 requests a part for this identified product. As with most information, it is stored in the customer's account in the customer account database 1230. The request is passed to parts database 1220 indicating the product identifier which may be a model number or serial number.

In step 2117 parts database 1220 looks up parts which potentially match the request from the user 3. These potential matches are provided to the mobile computing device 1100 running the app which displays the potential parts to the customer in step 2119.

In step 2121 the customer views the potential parts and selects the part.

In step 2123, the mobile device 1100 may connect with the e-commerce system 1300 to identify a location, and cost of the replacement part and possibly purchase the part.

Optionally, in step 2025, the user 3 cause the mobile device 1100 to add the replacement part to a shopping list to purchase later.

The process is finished at step 2027.

In an alternative embodiment, the system shown in FIG. 1 includes a product cache database 1250, and a parts cache database 1260 which are designed to increase throughput by simplifying the steps for searching the model type in step 2009 of FIG. 2, and the step of searching for the part once the model number is known in step 2017 of FIG. 2 and step 2117 of FIG. 3.

If the parts database 2010 searches through all the possible products for one which matches the product in the picture acquired by user 3 and mobile computing device 1100, it can take a long time if the database is not reduced and correctly organized. A product cache database 1250 of FIG. 1 can work to simplify the search by collecting information and making a few assumptions.

For example, all products are not sold in all stores. If the general category of product is identified, such as “lawnmowers”, this can simplify searching. For example, controller will know the location of user 3, so the lawnmowers sold from the local store in the last several years can be downloaded from product database 1210 into the product cache database 1250.

It is assumed that lawnmowers require more replacement parts as they get older. Also, there are fewer lawnmowers in operation over time. Therefore, crossing these two would result in a peak age (model year) in which parts are going to be requested. The product cache database 1250 can be reorganized to have data for the model years expected to have the most requests for parts first, followed by the years in which parts are typically not required. Product cache database 1250 downloads a subset of information in the product database 1210. This smaller subset is much easier to search. If the product model is not found in the product cache database 1250, then searching can continue as described in the original embodiment without product cache database 1250.

Further, if one knows generally the category of the product, “lawnmower”, then in step 2017 of FIG. 2, one can look up which parts are most often replaced. This can be downloaded from the controller 1240 to a parts cache database 1260. For example, if the most often replaced parts are blades, spark plugs and air filters, these may be organized and stored in order of replacement frequency by parts cache 1260. It is most likely that the part will be found by searching the entries for parts most often replaced instead of having to search through parts which are rarely replaced.

If the part is not found after searching the entire parts cache database 1260, then searching continues to the parts database 1220.

The product cache database 1250 and the parts cache database 1260 as described above reduce the search times considerably and increase throughput of the system.

Although a few examples have been shown and described, it will be appreciated by those skilled in the art that various changes and modifications might be made without departing from the scope of the invention, as defined in the appended claims.

What is claimed is:

1. A system for assisting a user in acquiring a replacement part for a product comprising:
a visual identification system adapted to acquire an image of a product, display product images to and receive user selections from a user to visually identify the product;
an open access parts database coupled to the visual identification system, adapted to acquire the product identification information from the visual identification system and provide a representation of at least one part of the identified product to the user, and receive a selection of the user as the replacement part.

2. The system for assisting a user of claim 1, wherein the visual identification system comprises:
a user interface adapted for displaying images to the user and receiving selections from the user;
an image acquisition device adapted to acquire an image of the product;
an image analysis device coupled to the image acquisition device, adapted to analyze the image to identify image features;
a product database having prestored images with image features relating to a plurality of products, each image also having associated product information;
an image search device coupled to the image analysis device and the product database adapted to search the image features of the product database to find similar product images and provide the similar product images to the user to select;
the image search device further adapted to receive the product image selected, and identify product identification information from the selected product image.

3. The system of claim 2, further comprising:
a product cache, being a subset of the product database having information on products sold at a store close to the user with the products being organized in an order with those products most likely to need replacement parts being first and those products least likely to need replacement parts being last.

4. The system of claim 2, further comprising:
a parts cache, being a subset of the parts database having information on the identified products model with the parts being organized in an order with those parts most likely to be replaced being first and those parts least likely to be replaced being last.

5. The system of claim 1, wherein the representation of at least one part is one of the group consisting of: an exploded image view, an interactive graphical depiction, a static graphical depiction, a hierarchical representation, a categorized representation, a text representation.

6. The system of claim 1, wherein the product identification information comprises at least one of the group consisting of: model years, price, and model specifications.

7. The system of claim 2, further comprising an account database which stores information for a plurality of users; and
the image search device is further adapted to store at least one of the group consisting of:
the acquired images, closest product matches, selected product, and parts for the selected product in the account database for future use in searching for replacement parts.

8. A novel method of acquiring a replacement part for a product comprising the steps of:
acquiring an image of the product;
searching an open access product database for images that are similar to the acquired image;
providing the similar images to the user to select;
receiving an indication of the product selected by the user;
searching an open access parts database to find parts of the selected product;
providing a representation of the parts of the selected product;
allowing the user to select a part; and
identifying the selected part as the replacement part.

9. The novel method of claim 8, further comprising the step of:
searching an ecommerce system to determine locations where the selected part may be purchased.

10. The novel method of claim 8, further comprising the step of:
searching an ecommerce system to determine the price and the estimated time of delivery if purchased on-line.

11. A system for assisting a user in acquiring a replacement part for a product comprising:
a visual identification system adapted to acquire an image of a product, interact with a user to visually identify the product;
an open access parts database system coupled to the visual identification system, adapted to receive the product identification and interact with the user to identify the replacement part; and
an ecommerce system, coupled to the open access parts database, adapted to indicate the location and availability of the identified part.

12. The system for assisting a user of claim 1, wherein the visual identification system comprises:
an image acquisition device adapted to acquire an image of the product;
a product database having prestored images of a plurality of products;
a controller coupled to the image acquisition device adapted to search the product database for those which most closely match the acquired image;
an interface coupled to the controller adapted to:
display images that are closest to the acquired image of the products to the user;
receive the user's selections of an image;
wherein the controller identifies the product based upon the user's selection.

13. The system for assisting a user of claim 2, wherein the open access parts database system is coupled to, and receives the identified product from the visual identification system, the open access database system comprises:
a parts database having prestored identifications of parts for each product;
a controller adapted to:
provide a representation of a plurality of parts for the identified product to the user through the interface;
interact with the user through the interface to receive a part selected by the user.

14. The system for assisting a user of claim 11, wherein the ecommerce system is remotely coupled to the open access parts database system and comprises:
an inventory database of various stores having a plurality of product parts, information on the product parts, and an indication of a number of each part in stock at each location;
a controller coupled to the inventory database adapted to:
receive the part selected by the user and a location where the user would like to purchase the selected part,
search the inventory database, and
indicate the stores within a predetermined radius of the location where the user would like to purchase the part which have the part in stock.

15. The system for assisting a user of claim 14, wherein the controller is further adapted to interact with the user to purchase the product on-line.

16. The system for assisting a user of claim 12, wherein the image acquisition device comprises a mobile computing device that is coupled by one of: Bluetooth, Wi-Fi, wired interface, and cellular communications.

17. The system for assisting a user of claim 12, wherein the images which are closest to the acquired image are defined as those which have less than a predetermined deviation from the acquired image.

18. The system for assisting a user of claim 13, wherein the representation of parts is one of the group consisting of:
an exploded image view, an interactive graphical depiction, a static graphical depiction, a hierarchical representation, a categorized representation, a text representation.

19. The system for assisting a user of claim 12, further comprising:
a user account database adapted to store information relating to a plurality of users;
wherein the controller is further adapted to store in the user account database at least one of: the acquired image, the matching products, the selected product, the identification of parts for the selected product, the selected part for a plurality of users in the user account database to facilitate future acquisition of replacement parts.

20. The system for assisting a user of claim 11, wherein:
the ecommerce system is further adapted to identify the cost and estimated delivery time if purchased on-line.
